(19) United States
(12) Patent Application Publication
(10) Pub. No.: US 2024/0272623 A1
(43) Pub. Date: Aug. 15, 2024

(54) OPERATING AND DISPLAY UNIT FOR A FIELD DEVICE

(71) Applicant: VEGA Grieshaber KG, Wolfach (DE)

(72) Inventors: Stefan KASPAR, Hofstetten (DE); Florian BURGERT, Gengenbach (DE); Christian LANGENSIEPEN, Herbolzheim (DE)

(73) Assignee: VEGA Grieshaber KG, Wolfach (DE)

(21) Appl. No.: 18/566,886

(22) PCT Filed: Jun. 22, 2022
(86) PCT No.: PCT/EP2022/066970

§ 371 Date: Dec. 4, 2023

(30) Foreign Application Priority Data
Jun. 25, 2021 (EP) 21181787.9

(51) Int. Cl. G05B 19/418; G06K 7/14

(52) U.S. Cl. CPC G05B 19/41835; G06K 7/1417; G05B 2219/31229

(57) ABSTRACT

A controller and display for identifying a field device is provided, including: an internal register configured to store an identification of the field device; and a representation device configured to provide a coded representation of the identification, the coded representation of the identification including an identifier. A method of representing an identification of a field device is also provided.

### FIELD OF INVENTION

The invention relates to a control and display unit for identifying a field device, a field device with a control and display unit, a method, a use, a program element, and a computer-readable medium.

### BACKGROUND

In process and factory automation, field devices are used for monitoring and controlling processes, which are identified, for example, by means of a type plate. Such field devices can be used, for example, to determine a filling level, limit level or type of filling medium, and/or to monitor other process parameters. The identification of such field devices can be impaired if the type plate—due to damage—is more difficult or no longer legible.

### SUMMARY

It is an object of the invention to improve an identification of a field device. This object is solved by the subject-matter of the independent patent claims. Further embodiments of the invention result from the subclaims and the following description.

A first aspect relates to a control and display unit for identifying a field device. The control and display unit comprises an internal register, which is arranged to store an identification of the field device. The identification of the field device may be stored exclusively in the field device; alternatively or additionally, the identification may be stored on a server, a database, and/or on another electronic device and/or medium, and/or, for example, as a badge on the device. The identification of the field device may, for example, include a serial number of the field device, and/or be performed or supported by means of the serial number and/or other identification features. The control and display unit comprises an internal register. The internal register can be implemented, for example, as a non-volatile memory, e.g., as a flash memory, as a WORM memory (WORM: Write Once Read Many), such as an EEPROM (Electrically Erasable Programmable Read Only Memory), EPROM (Erasable Programmable Read-Only Memory), and/or as an unalterable memory, e.g., as a PROM (Programmable Read-Only Memory). The reading of the register contents into the internal register can be done e.g. by means of a camera, e.g. by reading a nameplate of the field device. The nameplate may comprise, for example, a QR code and/or a barcode.

The internal register may further comprise, e.g., in an embodiment, an authentication feature, such as an authentication code, e.g., a private key.

Furthermore, the control and display unit has a representation unit which is configured for a coded display of the identification. The coded representation can, for example, be coded as plain text, as an at least partially encrypted display, as a barcode, as a QR code (QR: “Quick Response” code) and/or in another representation. The representation unit may, for example, be implemented as a display. The representation unit can, for example, be designed as a flashing LED that emits a light signal—e.g. in the form of a sequence as in Morse code or other coding. Furthermore, the representation unit can be designed as a near-field communication module, which emits the coded signal, e.g. by means of RFID (Radio-Frequency Identification). The representation unit can include a computing unit that is used, for example, to encode the identification.

The coded representation of the identification may comprise an identification feature and, optionally further, an authentication feature. The coded representation of the identification may be determined, for example, by means of a computing and control unit that may be part of the representation unit and/or the field device. If, for example, the coded representation is shown as a QR code on the display, then, for example, the identification of the field device may be stored in the internal register as a number, as a string, etc., and the computing and control unit performs a conversion of the internal register content in accordance with the regulations for a standard-compliant representation of QR codes.

The coded representation may include a first generally readable field, such as a serial number and a type of field device, and a further field that may be evaluated by a control device of a two-wire loop, i.e., for communication with the field device. At least part of the coded representation of the identification may be a coded representation. For example, the encoded representation may appear on the display always, at startup, and/or on request. In at least some cases, only the serial number may be represented. In some cases, the encoded representation or portions thereof may be cleared after a predefined time. Advantageously, the field device identification may always be displayed, e.g., in conjunction with a low energy display such as e-paper. Advantageously, this may help to make the field device identification more frequent (e.g., always) and/or more readable, e.g., compared to a plaque on the device, which may, e.g., fade and/or become scratched.

The control and display unit can include, for example, a display that can be connected to a field device. This can be used, for example, to display a QR code of the nameplate of the field device. The display may show the QR code or other representation or coding of the particular device on which it is mounted. This QR code may, for example, be represented on the nameplate in accordance with a standard—e.g. DIN SPEC 91406:2019-12 “Automatic identification of physical objects and information on the physical object in IT systems, esp. ndere IoT systems; Text German and English”. The QR code in the display can establish a (e.g., logical) link of the device to a so-called “digital twin”, e.g., by providing the QR code with a link to a documentation, parameter setting, history, firmware, test protocols, drawings, device status, etc. of the field device. Furthermore, the QR code in the display can be used to obtain authorization for device access (“login”).

Another advantage of the present disclosure may result from secure authentication on the field device. For example, in a case where the field device has an interface for remote access, the QR code in the display may serve as an indicator that the user is very close to the device—e.g., within sight of the device. This can advantageously reduce a risk of dial-up and/or authentication on the wrong device.

According to an embodiment, the authentication feature is set up to authenticate a user device. The user device may be, for example, a mobile device, such as a smartphone, tablet, or laptop. The dial-in mechanism may be designed, for example, such that the mobile device reads the identification feature and/or the authentication feature, e.g., by means of a camera, and on this basis is connected to the correct device, e.g., via an authentication server and/or via decentralized mechanisms, such as via a seed-based authenticator.

According to a further embodiment, the authentication feature is mutable. For example, the authentication feature may be encoded as a nonce or using a nonce and/or otherwise. The mutable authentication feature may be stored solely in the field device; alternatively or additionally, the identification may be stored on a server, database, and/or other electronic device and/or medium. The authentication feature may change after each connection is established to increase security. For example, the QR code may be dynamically adjusted for security purposes.

According to a further embodiment, the identification feature and/or the authentication feature of the field device can be received by means of the representation unit over a distance between 0 m and 2 m, in particular between 0 m and 0.5 m, for example between 0 m and 20 cm. In one embodiment, at least one of these features can only be receivable within an NFC (near field communication) range.

This may help to identify the field device only over a short distance, i.e., in a close range. A first advantage of this embodiment is the establishment of eye contact, i.e., a clear association between the field device and the controlling device. A second advantage of this embodiment is that by being able to identify the field device only at close range, another device is not inadvertently controlled.

According to a further embodiment, the representation unit is embodied as a display, as a near-field communication module, as a light signal, and/or otherwise. The term “display” is to be understood broadly. The display may be, for example, an LCD (liquid crystal display) display, electronic paper (e-paper), an LED (light emitting diode) display, e.g., in the visible or infrared range, and/or some other representation. The light signal may alternatively or additionally be, for example, a flashing LED. It may prove advantageous to avoid operating a wrong field device by the close range identification of the field device, which promotes eye contact with the field device. As a further advantage, it may be considered that only authorized persons can operate the field device.

The encoded information can also be generated in the form of a 1D code type (e.g. Code128) or 2D code type (e.g. DataMatrix) and shown on the display. As an alternative to a QR code, the transmission of the information can be carried out via near-field radio technologies such as NFC (Near Field Communication), RFID (Radio-Frequency Identification), Bluetooth and/or others.

According to a further embodiment, the representation unit is implemented as part of a detachably connected unit of the field device and/or as part of an external display device. For example, the representation unit can be plugged directly into the field device and/or connected via the two-wire loop.

The QR code can also advantageously be displayed on an external display unit, e.g. if the instrument is mounted in an inaccessible location. For example, an external representation unit can be used, e.g. VEGADIS 81 or VEGADIS 82 from VEGA. A detachably connected indicating unit is easily interchangeable, e.g. between field instruments. Thus, advantageously, a correct indication of the identification can be given in a familiar format. The detachably connected indicating unit can be designed e.g. plug-in, screw-on, connected by means of a bayonet lock, etc. on the field instrument.

According to a further embodiment, the operating and representation unit is designed as part of a device arranged in a two-wire loop.

Through the two-wire loop, the device is at least indirectly connected to a server and/or a database. The connection by means of a two-wire loop can be used to realize the authentication of the user device.

According to an embodiment, the control and display unit has a communication module that is set up to authenticate the user device and/or to communicate with the user device. The communication module can be designed, for example, as a radio module suitable for communication between the field device and the user device. The reading of the register contents may be performed at least in part via a camera, which may be directed, for example, at the nameplate of the device.

One aspect of the present disclosure relates to a field device comprising a control and display unit and/or a display unit.

An aspect relates to a method for presenting an identification of a field device. The method comprises the steps of:
Providing the identification in an internal register of the field device;
Coding the identification into an identifier and an authenticator;
Representing the coded identification by means of a representation unit, wherein the coded representation of the identification comprises the identification feature and the authentication feature.

The aim of this method is to identify the field device, e.g. for a unique assignment between e.g. the field device and the control unit.

According to an embodiment, the following steps are performed:
Detection, by means of a detection unit in a mobile device of the identification feature and/or the authentication feature;
Transferring the identifier and/or authentication feature to a server;
Authenticate a communication between the field device and the mobile device.

The acquisition unit may be arranged in a mobile device, e.g., a smart phone that includes, for example, a camera or near-field communication module and/or a special Bluetooth module. The server may be both a program and a device, e.g., control station, feed module. The server may also be a control station and control module of the two-wire loop. The authentication can have several levels, e.g. from a low level “read only”, to “maintenance”, etc., to “admin”.

According to an embodiment, the provision of the identification during the manufacture of the field device is performed by means of a transmission in a two-wire loop and/or by means of a capture unit. The capture unit may be, for example, a camera unit arranged to capture a QR code of the device or near field communication.

An aspect relates to using a control and display unit of a field device to display an identification of the field device and/or to authenticate a user device.

An aspect relates to a program element that, when executed on a field device, a mobile device, a server, and/or on another computing device, instructs the field device, the mobile device, the server, and/or the computing device to perform the method steps described above and below. For example, the program element may be executed as an app on at least one of these devices.

One aspect relates to a computer-readable medium on which a program element described above is stored.

For further clarification, the invention is described with reference to embodiments illustrated in the figures. These embodiments are to be understood only as examples and not as limitations.

### BRIEF DESCRIPTION OF THE FIGURES

Thereby shows:

FIG. 1 schematically the identification of a field device on a server.

FIG. 2a schematically a control and display unit with a control and power supply module of the two-wire loop according to an embodiment.

FIG. 2b schematically a control and display unit with a control and power supply module of the two-wire loop according to a further embodiment.

FIG. 3a schematically a perspective view of a control and display unit according to an embodiment.

FIG. 3b schematically a perspective view of a control and display unit according to an embodiment.

FIG. 3c schematically a perspective view of a control and display unit according to an embodiment.

FIG. 4 a flow diagram of a method according to an embodiment.

### DETAILED DESCRIPTION OF EMBODIMENTS

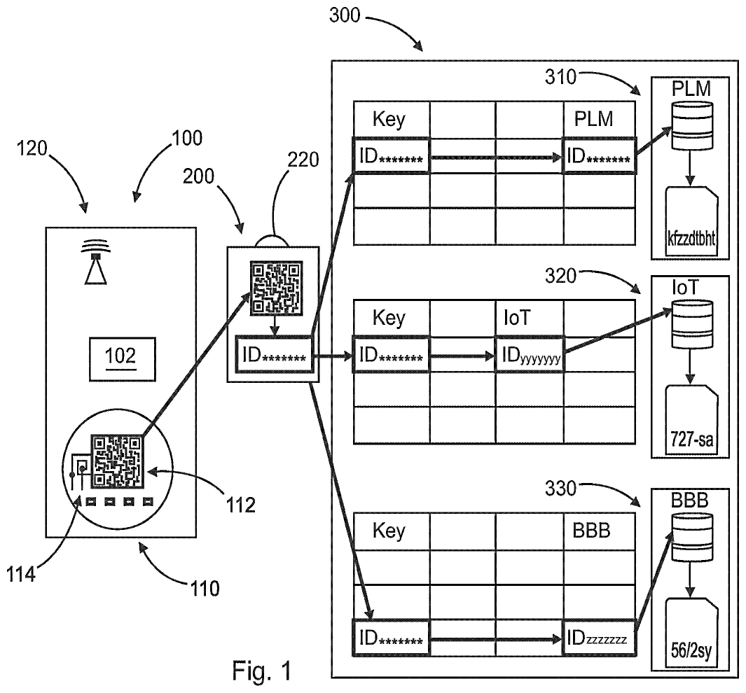

FIG. 1 schematically shows the identification of a field device 100 on a server 300, by means of transmission of an identification feature and/or an authentication feature of the field device 100 between a control and display unit 110, a detection unit 220 of a user device 200, and a server 300. The control and display unit 110 comprises an internal register 102, which is arranged to store an identification of the field device 100. The identification of the field device 100 may include, for example, a serial number of the field device 100, and/or may be implemented as a serial number or as another identification feature. For example, the internal register 102 may be implemented as a non-volatile memory, such as a flash memory, a WORM memory (WORM: Write Once Read Many, such as EEPROM, EPROM, etc.), and/or an immutable memory. The internal register 102 may further comprise, for example, an authentication code, such as a private key. Reading of the register contents may be performed by an acquisition unit 220 of the user device 200, for example by reading the nameplate. The capture unit 220 may be a camera.

Furthermore, the control and display unit 110 has a representation unit 112, which is set up for a coded display of the identification. The representation unit 112 can, for example, be designed as a display. The representation unit 112 can be designed as a flashing LED that transmits a light signal. Further, the representation unit may comprise a near-field communication module 114. The representation unit 112 may include a computing unit that is used, for example, to encode the identification. The encoded representation of the identification may include an identifier and an authentication feature. The encoded representation of the identification may be determined, for example, by means of a computing and control unit that may be part of the representation unit 112 and/or the field device 100. The coded representation may include a first generally readable field, e.g., serial number and type of the field device, and a second field that may be evaluated by a control unit of a two-wire loop, i.e., for communication with the field device. At least part of the coded representation of the identification may be a coded representation.

The LCD display 112 may, for example, display the QR code of the nameplate of the field device 100. The display 112 may show, for example as a QR code, the identification feature of the respective field device 100 on which it is mounted. Alternatively or additionally, the display 112 may show, for example, an authentication feature of the field device 100. The authentication feature may be arranged to authenticate the user device 200. The authentication feature may be changeable, for example, depending on the authentication protocol used.

Further, the user interface and display unit 110 includes a communication module 120. The communication module 120 may be configured to authenticate the user device 200 and/or to communicate with the user device 200. The communication module 120 may be implemented, for example, as a radio module. The radio module 120 may be for communication between the field device 100, the user device 200, and/or the server 300.

The authentication feature may be mutable. For example, the authentication feature can be coded as a nonce and/or otherwise. The authentication feature may change after each connection establishment to increase security.

An identifier and/or an authenticator in this embodiment is a QR code of the nameplate of the field device 100. The QR code may change after each connection is established to increase security and may be dynamically adapted. For example, the user device 200 may be a mobile device, e.g., smartphone, tablet, laptop.

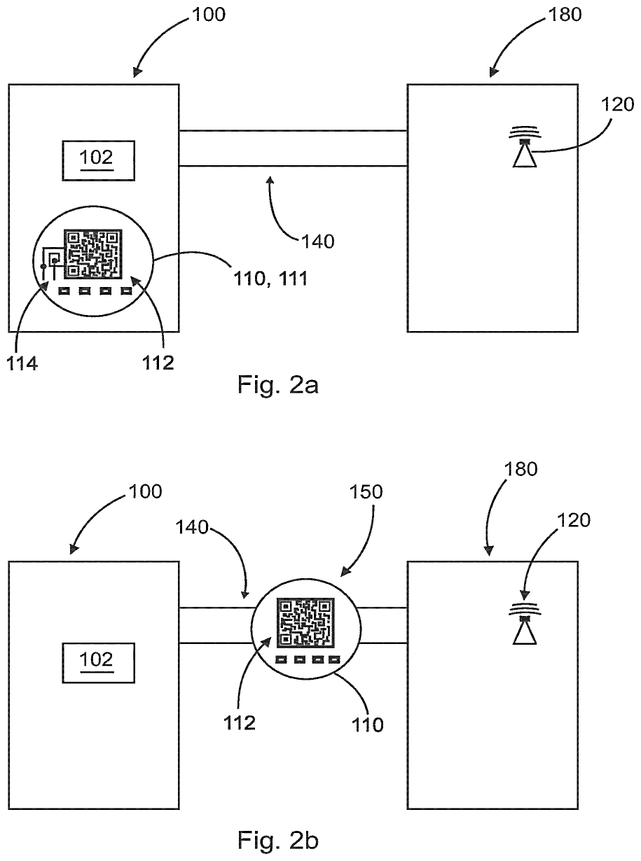

The server 300 may be a program as well as a device, e.g., a control station, a control and/or power module of a two-wire loop, etc., e.g., in the two-wire loop as shown in FIG. 2a or FIG. 2b.

Different databases can be stored on the server 300, which allow the identification of the field device in a backend system. The reference sign 310 designates an identification of the field device 100 in a PLM system (PLM: Product Lifecycle Management). 320 denotes an identification of the field device 100 in an IoT system (IoT: Internet of Things). The QR code can provide identification of the field device to a digital twin (documentation, parameter setting, history, firmware, test proto collect, drawings, device state) into a database. For example, the standard of coding DIN SPEC 91406:2019-12 “Automatic identification of physical objects and information about the physical object in IT systems, in particular IoT systems; text German and English” allows physical objects to be uniquely realized via a link for identification stored in a QR code. 310 denotes an identification of the field device 100 in a BBB system (BBB: BigBlueButton, an open source web conferencing system).

FIG. 2a shows a field device 100 with a control and display unit 110 according to a further embodiment. The representation unit 112, 114 is designed as part of a detachably connected unit 111 of the field device 100. Advantageously, the detachably connected unit 111 is designed to be interchangeable between the field devices. The detachably connected unit allows the correct display in a usual for the field device format, e.g. DIN SPEC 91406:2019-12. The detachably connected unit 111 may, for example, be plug-in by means of connectors 105 or screw-on by means of contacts 108.

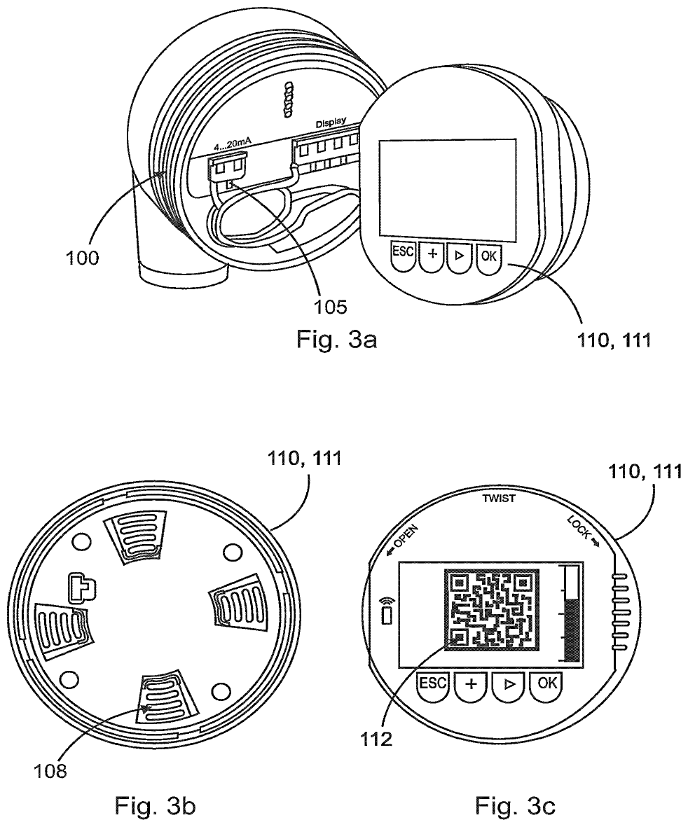

FIG. 3a shows an embodiment in which the field device 100 is connected to the control and display unit 110 by means of electrical connections 105. It can be seen that this embodiment of the control and display unit 110 is designed as a detachable unit 111.

FIG. 3b illustrates an embodiment in which the detachable unit 111 includes electrical contacts 108 corresponding to terminals 105 on the field device for attachment to the field device 100.

FIG. 3c shows an embodiment in which the representation unit 112 is implemented as an LCD display or an e-paper. As an example, the representation unit 112 shows a QR code that can be used to identify the field device. The QR code can be implemented, for example, as a “lock or idle screen” that is shown when, for example, no display of a measured value and/or further values takes place.

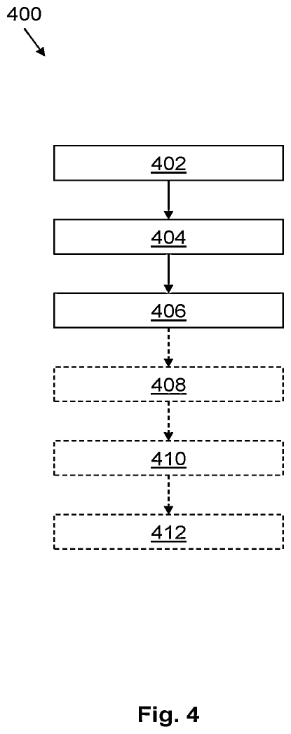

FIG. 4 illustrates a flowchart 400 of a method of providing an identification of a field device according to one embodiment of the present disclosure. In a step 402, an identification is provided in an internal register 102 of the field device 100. In a step 404, the identification is encoded into an identifier feature and an authentication feature. In a step 406, the encoded identification is represented using a representation unit 112, wherein the encoded representation of the identification comprises the identification feature and the authentication feature. The representation unit 112 may include a computing unit, for example, for encoding the identification. In this method, a unique association is performed between, for example, the field device and the control device.

In an optional step 408, the identification feature and/or the authentication feature is captured by means of a capture unit 220 in a mobile device 200. In an optional step 410, the identification feature and/or the authentication feature is transferred to a server 300. In an optional step 412, a communication between the field device 100 and the mobile device 200 is authentified. The authentication may have multiple levels, e.g., “read only readings” level, via “maintenance”, “admin”, etc.

Providing the identification of the field device 100 in an internal register 102 may be performed when the field device 100 is manufactured. Providing the identification of the field device may be performed by means of a transmission in a two-wire loop 140 and/or by means of a capture unit 220. The capture unit 220 may be, for example, a camera unit used to capture a QR code of the field device. The capture unit may capture a near-field communication module, such as an RFID chip or an antenna of Bluetooth technology.

### LIST OF REFERENCE SIGNS

100 Field device
102 Internal register
105 Connections for a control and display unit
108 Contacts of a control and display unit
110 Control and display unit
111 Detachably connected unit
112 Representation unit, display
114 Representation unit, near field communication
120 Communication module
140 Two-wire loop
150 External display device
180 Control and supply module of the two-wire loop
200 User device, mobile device
220 Capture unit
300 Server
400 Flowchart
402-412 Steps

1.-15. (canceled)

16. A control and display unit for identifying a field device, comprising:
an internal register configured to store an identification of the field device; and
a representation unit configured to provide a coded representation of the identification,
wherein the coded representation of the identification comprises an identifier.

17. The control and display unit according to claim 16, wherein the coded representation of the identification further comprises an authentication feature.

18. The control and display unit according to claim 17,
wherein the authentication feature is configured to authenticate a user device, and/or
where the authentication feature is mutable.

19. The control and display unit according to claim 16, wherein the identification feature and/or the authentication feature of the field device is receivable by means of the representation unit over a distance between 0 m and 2 m.

20. The control and display unit according to claim 16, wherein the identification feature and/or the authentication feature of the field device is receivable by means of the representation unit over a distance between 0 m and 0.5 m.

21. The control and display unit according to claim 16, wherein the identification feature and/or the authentication feature of the field device is receivable by means of the representation unit over a distance between 0 m and 20 cm.

22. The control and display unit according to claim 16, wherein the representation unit is implemented as a display, a near-field communication, and/or a light signal.

23. The control and display unit according to claim 16, wherein the representation unit is implemented as part of a detachably connected unit of the field device and/or as part of an external display device.

24. The control and display unit according to claim 16, wherein the control and display unit is implemented as part of a device arranged in a two-wire loop.

25. The control and display unit according to claim 16, further comprising a communication module configured to authenticate a user device and/or to communicate with the user device.

26. A field device, comprising a control and display unit and/or a representation unit according to claim 16.

27. A method of representing an identification of a field device, the method comprising the steps of:
providing the identification in an internal register of the field device;
encoding the identification into an identifier; and
representing the coded identification by means of a representation unit according to claim 16,
wherein the coded representation of the identification comprises an identification feature and an authentication feature.

28. The method according to claim 27, wherein the encoding step further comprises additionally encoding the identification into an authenticator.

29. The method according to claim 27, further comprising the steps of:
capturing, by means of a capture unit in a mobile device, the identification feature and/or the authentication feature;
transferring the identifier and/or the authentication feature to a server; and
authenticating a communication between the field device and the mobile device.

30. The method according to claim 27, wherein the providing of the identification is performed during manufacturing of the field device, by means of a transmission in a two-wire loop and/or by means of a detection unit.

31. The control and display unit according to claim 16, wherein the control and display unit is configured to display an identification of a field device and/or to authenticate a user device.

32. A nontransitory computer-readable medium having stored thereon instructions that, when executed by a processor of a field device, a mobile device, a server, and/or another computing device, causes the field device, the mobile device, the server, and/or the another computing device to perform the method according to claim 27.
